(19) United States
(12) Patent Application Publication
(10) Pub. No.: US 2005/0149530 A1
(43) Pub. Date: Jul. 7, 2005

(54) Communication and information processing system

(76) Inventor: Abhay Oswal, Rancho Santa Fe, CA (US)

Correspondence Address: Law Offices of James C. Weseman, Suite 1600, 401 West A Street, San Diego, CA, 92101, US

(21) Appl. No.: 11/029,719

(22) Filed: Jan. 4, 2005

Related U.S. Application Data
(60) Provisional application No. 60/534,775, filed on Jan. 6, 2004.

(51) Int. Cl. G06F 17/30

(52) U.S. Cl. 707/10

(57) ABSTRACT

A system for exchanging and processing information between a remote device communicating with a network server to enable remote users, employing a variety of devices and modalities, to interact, generate, process, store and disseminate content and information at any time and from any location.

### TECHNICAL FIELD

The present invention is directed to information processing systems that allow mobile users to interact, generate, process, store and disseminate content and information.

### BACKGROUND OF THE INVENTION

Systems have existed for exchanging and processing information between network server-based applications and remote users. However, heretofore such systems are not known to enable users to create information and content at all times, locations and using many device types and modalities, nor are they capable of capturing information about an event immediately, on-the-fly at the place and time it actually occurs, and automatically stamping that information with the date, time, location and pertinent detail regarding the initiating user. Current systems provide exchange of information without the ability to conveniently create, track and disseminate it whenever and wherever a remote user may happen to be.

Prior systems also are not known to enable generated information or content to be stored in a manner that is independent of the generation or display modality, or to dynamically format information for display dependent on the display modality and device.

Accordingly, numerous objectives of the present invention are intended to remedy perceived deficiencies in currently available systems for exchanging and processing information between network server-based applications and remote users, and will become apparent from the following disclosure and detailed description.

### DISCLOSURE OF THE INVENTION

The present invention provides systems for exchanging and processing information between at least one remote device and at least one network server to enable remote users, employing a variety of devices and modalities, to generate, process, store and specifiably disseminate content and information at any time and from any location.

In one aspect, the present invention provides a system for exchanging and processing information between a remote device communicating with a network server. The system comprises at least one user-interactive remote device including a computer platform having a client agent resident therein, where the device is in selective communication with a network, together with at least one network server having a server agent resident therein, the network server in selective communication with the network and the remote device, and the network server having a data output interface for providing access to data. In the system, the client agent selectively communicates data provided in at least one predefined format by the user of the remote device to the server agent for processing by the server agent and the generation of data accessible through the data output interface, and the server agent selectively communicates data in at least one predefined format to the client agent for processing by the client agent, to other destination client agents, and/or processes data received and makes that accessible to the user of the remote device.

In other aspects of the invention, the server agent can extend (or iterate) the above process to include reception of feedback from at least one destination client agent. It can then process, store and disseminate such responses for access by the initiating user, or by the aggregate of initiating and destination users/agents. This cycle can be repeated until a given transaction is concluded.

### BRIEF DESCRIPTION OF THE DRAWINGS

FIG. 1 illustrates a general framework and selected applications in which the invention can be employed;

FIG. 2 is a diagrammatic illustration showing various entities that can advantageously be interconnected in one embodiment of the invention;

FIG. 3 is a flowchart of one process of generating content from information received from a remote user and transmitting the processed content in a report format for access by the user; and

FIG. 4 is a flowchart illustrating the method and operation of one embodiment of the present invention.

### DETAILED DESCRIPTION OF THE INVENTION

The present invention provides systems for exchanging and processing information between at least one remote device and at least one network server to enable remote users, employing a variety of devices and modalities, to generate, store and disseminate content and information at any time and from any location.

In one aspect, the present invention provides a system for exchanging and processing information between a remote device communicating with a network server. The system comprises at least one user-interactive remote device including a computer platform having a client agent resident therein, where the device in selective communication with a network, together with at least one network server having a server agent resident therein, the network server in selective communication with the network and the remote device, and the network server having a data output interface for providing access to data. In the system, the client agent selectively communicates data provided in at least one predefined format by the user of the remote device to the server agent for processing by the server agent and the generation of data accessible through the data output interface, and the server agent selectively communicates data in at least one predefined format to the client agent for processing by the client agent, to other destination client agents, and/or processes data received and makes that accessible to the initiating user.

In other aspects of the invention, the server agent can extend (or iterate) the above process to include reception of feedback from at least one destination client agent. It can then process, store and disseminate such responses for access by the initiating user, or optionally by the aggregate of initiating and destination users/agents. This cycle can be repeated until a given transaction is concluded.

The present invention provides a system including hardware, software and network architecture elements, and a set of services coupled with the system for enabling remote users employing a variety of devices and modalities to generate, store and disseminate content and information at any time and from any location. Also, other parameters, such as the identity of the user, the location, the date and the time can be recorded without entry of this information by the user. This newly created information is transmitted from the remote device in real time, or at the earliest opportunity, to a central server whereby it is processed, forwarded, or segregated and broadcast to one or more destinations. The system is capable of receiving, processing, and selectively forwarding appropriately formatted responses from such destination device(s) in the reverse direction to the originating remote device. The information can be retrieved either individually or as part of a set of information, which can be grouped together using user defined parameters to create user-specified content. Furthermore, the system is capable of tracking and archiving this communication activity for post processing, printing, reporting, and/or preservation.

The present system will be accessible using a variety of networked or networkable devices, termed remote devices, such as, but not limited to, cell/mobile phones, smart phones, wireless telephones, PDAs, custom mobile data devices, messaging devices, electronic tablets, touch input screens, electronic chalkboards (or whiteboards), PSTN (standard phone network) or other network connected devices, and computers. Networkable devices are defined to be devices that can be networked to other devices but do not necessarily need to be networked at the time of use of the application. For example, a PDA without an Ethernet or wireless network connection, but with the capability to be connected to a computer using infrared (IrDA), USB, serial (RS-232) or other means, is an example of a networkable device. Similarly, even a PDA which can save the application data onto a physical device, such as flash memory, and this physical device can then be made available to another computer qualifies as a networkable device.

In addition to the above general achievements the following are features of the system (framework and services) of the present invention described above:
1. A large number of specific applications can be built on the system.
2. The system allows actions to be assigned on an application specific basis, dependent on the information or content being generated.
3. The system enables entities to create or transform content using cooperative and reactive interactions.
4. The system provides mechanisms for documentation and tracking of such interactions and content.
5. The system provides sufficient sophistication and security for use in the development of enterprise level applications and for interacting with enterprise information systems.
6. The system enables real-time content generation.
   Examples of applications that can be built based upon the system of the present invention are:
Real-time expense tracking:
   Expense tracking using the current most-accessible device (CMAD) such as cellphone, PDA, portable or fixed terminal computer for data input, and the ability to generate expense reports on a different device at a later time. Also, the ability to connect to an enterprise or corporate system for real-time expense tracking and reporting.
Real Time Inventory Tracking
Project management:
   Creation and management of a project or projects in a distributed fashion using CMAD's for tracking, notification, receiving feedback/responses and updating.
Content sharing:
   General content sharing for networked devices (for example access of address book on home computer from a cell phone)
Monitoring device data (medical and other):
   Collection of data from monitoring devices and sending of messages in response to measured data values. For example real-time monitoring of patient blood glucose levels and automatic reminder via cell phone in the event that level is outside the acceptable range. The patient's physician could also be notified automatically for certain conditions.
Mobile blogging:
   The system adds a new dimension to blogging by allowing for real-time updating of blogs from CMAD. It makes content generation and dissemination very fast. It can be extended to news reporting, and can further be extended by using voice and language recognition tools. For instance, the use of cellular phone with picture taking capabilities creates a new means to generate blogs, which include both visible images and audible information.
Event notification: Semi-automatic notification of an event behind (or ahead of) schedule, for example, when a device senses that the user is late for a prescheduled meeting (based on its knowledge of location of the device and the location of meeting), it can prompt the user for permission to auto-notify the meeting site.

Others systems and methods exist that send information to server based applications, however the present invention provides a number of improvements including:
The system enables entities to create information and content at all times, locations and using all devices and modalities. For example, it is capable of capturing the information about an event immediately, on the fly at the place and time it actually occurs, and it can automatically stamp that information with the date, time, location and pertinent detail regarding the initiating user. Current systems provide access to information without the ability to create and disseminate it.
It enables generated information or content to be stored in a manner that is independent of the generation or display modality.
It enables information to be dynamically formatted for display dependent on the display modality and device. It takes into account strengths, weaknesses and limitations of the device and connection.
It provides mechanism for initiating actions based on the content created. Actions can be at local or networked, remote devices. It is able to initiate communication over different networks.
Whenever possible, it makes use of voice input, and does away with, or minimizes, data entry via keystrokes or pen. This facilitates quick data entry, especially by a user on the go, is more intuitive, convenient, and user friendly. The user is typically prompted by synthesized voice, and can respond with words from a dynamically expandable vocabulary, or a few keystrokes/button presses if necessary.
Voice entry facilitates user identification or verification.
   The invention is not limited to a single language and it adapts easily to any language or accent.
   It allows multiple entities to interact, possibly in real-time for creation and communication of the content using a variety of devices and modalities. The types of devices can include, but are not limited to:
      a) A mobile communication device like a cell-phone
      b) A smart-phone
      c) A networkable Personal Digital Assistant (PDA)
      d) A networkable PC tablet with pen, keyboard, and/or voice input/output.
      e) A specialty networkable device with appropriate input/output facility
      f) A computer of any form factor (laptop, desktop, workstation) and
      g) PSTN devices
The captured information is transmitted from the capture device to a remote location thereby preventing information loss if the capture device is lost or misplaced.
The invention provides via a specified medium a simple, very convenient, automatic report of a set of correlated information upon completion, or by request. The reported items in the report contain the date, time, location (if available), and the identification of the user, without requiring user effort.
   Hardware and Software Elements

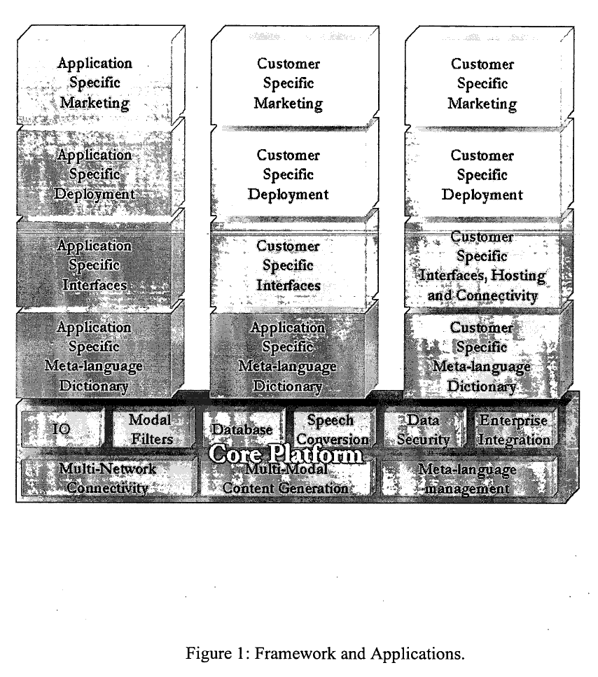

Turning now to the additional drawings, a general overview of a framework, with hardware, software, and user specific applications, used in accordance with the invention is shown in FIG. 1. As disclosed previously, numerous remote devices will find use in the present invention. Generally, such remote devices include, but are not limited to, a variety of networked or networkable devices, such as cell/mobile phones, smart phones, wireless telephones, PDAs, custom mobile data devices, messaging devices, electronic tablets, touch input screens, electronic chalkboards (or whiteboards), PSTN (standard phone network) or other network connected devices, and computers.

The server hardware typically utilized in the invention would include, but are not limited to, any Multi-Network datalink servers (MNDS) used to communicate with different connected devices. The MNDS would be the physical location in which the associated software used to manage the Core Platform would reside. An MNDS is connected to the Internet, and some MNDS devices can have direct connections to servers within corporate/enterprise information systems or to servers within mobile and fixed communication provider networks, depending on the application. The MNDS manages the connections, communications and the data related to the application in the present system. Multiple MNDS can be used for a single application to partition the functionality of the application between servers, provide load balancing or both. A single MNDS can also be used to support multiple applications. Access to the services provided by an MNDS can be limited to subscribers. The MNDS is capable of performing subscriber auditing and billing by either having an auditing functionality hosted by itself or by an associated computation platform.

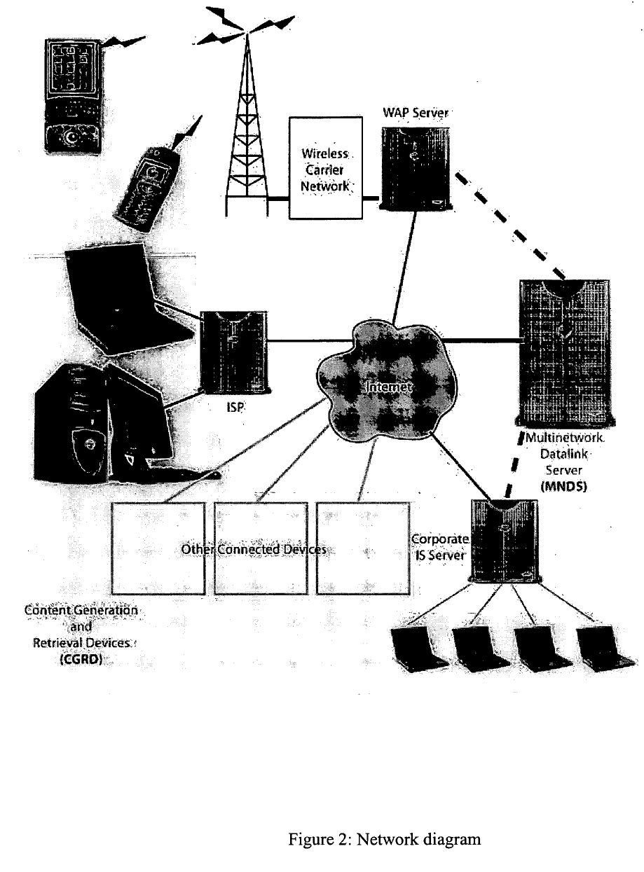

Also utilized in the present system are Content Generation and Retrieval Devices (CGRD). Selected typical CGRD's are shown in FIG. 2 and these can include, but are not limited to; a mobile telephone, a smart-phone, a Personal Digital Assistant (PDA), a PC tablet a laptop, or even a desktop, computer. CGRD's are networked or networkable and have the ability to be used as input or display devices. These devices are portable, networkable, possibly supporting voice input/output, and with or without keyboard entry. These devices are manufactured by third parties and are non-specific to this invention. To use a CGRD with the invention it may be required that some software be installed on the CGRD. This software can be pre-installed or dynamically downloaded during the use of the application. It may also be desirable that, instead of software provided by the present system, a standard interface already available on the CGRD (for example a web browser) is used to interact with the application.

One representative Core Platform and its associated software are shown in FIG. 1. In this example the various software elements are as follows:

The Multinetwork connectivity provides functionality for connecting with different networks including initiation of transactions with devices and servers on the network and response to requests from devices and servers on the network. Examples include wireless service provider networks, satellite service provider networks, corporate networks, and Internet connected servers and devices.

The Database operation provides functionality for storage of information in a database. The Multi-modal interaction provides functionality for interaction of the application with different CGRD in an optimal fashion. It includes functionality for identifying the CGRD type and capabilities either by interrogation of the CGRD or by lookup in a database. In addition the network used for the transmission and its particular parameters are also determined. CGRD capabilities are leveraged to optimize the ease and effectiveness of user interactions. In essence this software component creates a network-device model for use of other components.

The Multi-modal content display provides functionality for converting data and information into a format suitable for display on any CGRD.

The Meta-language management framework provides functionality for the development of applications by using a meta-language describing the functionality of the application. Each meta-language has a dictionary that describes the application information, properties of the information (e.g. evolution over time or dependence on location), interactions with users, information presentation requirements and actions triggered by information items or their values (or the evolution of these values). The underlying hardware and software can thus be leveraged to develop different applications by providing different meta-language dictionaries. As an example, if the content is transmitted using an XML document, the Document Type Definition (DTD) file for the XML document would be the “meta-language dictionary” in the terminology of the present invention.

Data security provides functionality for security of data stored on a MNDS as well as security during transmission to or from the MNDS.

Enterprise integration provides functionality for coexisting and communicating with enterprise information services and corporate servers.

Finally, Hooks for added functionality provides functionality for adding application specific or more general functionality through third party solutions at any step of the software process. This could be a set of published interfaces, protocols or any other well-defined interaction method. For example a speech processing or a speech generation capability could be added to the MNDS by using a hook into the software system.

Associated with the Core Platform are specific applications, which utilize the transmitted information for the creation of user specific content. For example a series of business transaction can be combined into a user-defined report. This can be accomplished by having appropriate connectivity to all modalities of information exchange, and by utilizing network-based storage of the information. The information is stored in a meta-language non-specific to any modality or device used for generating or accessing it. A Meta-language dictionary specific to the user application is used and support for the rich meta-language dictionary allows for both descriptive and active language elements (or tags). Active language elements result in the performance of actions (e.g. a phone call or an email). Finally, dynamic interpretation of meta-language data for display on specific devices and modalities can be used.

Alternatively, the MNDS can be placed within a more restricted network than the Internet, for example within a wireless service provider network or a corporate network. In addition, depending on the application, all of the previously identified subcomponents may not be required. Furthermore, the MNDS can include added functionality for processing information, for example audio, images or video. The mechanism for adding such functionality is described above.

Representative Application Embodiments

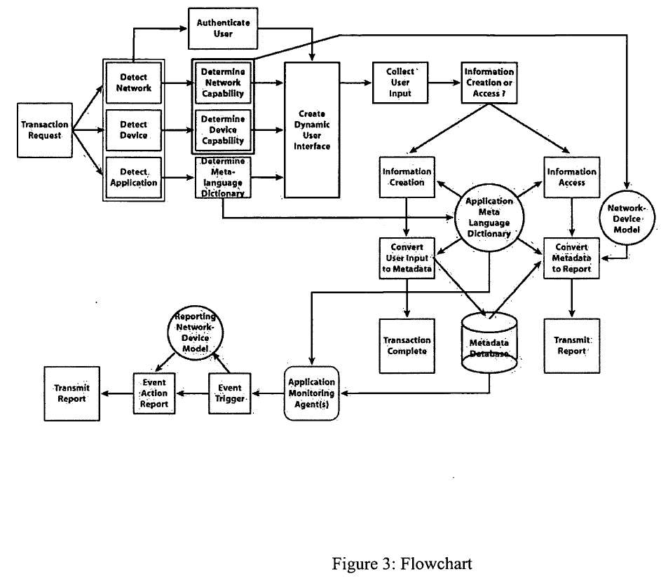

FIG. 3 depicts a general flow chart used by the invention. In this example, FIG. 3 shows the information processing flow for a transaction which is one embodiment of the invention.

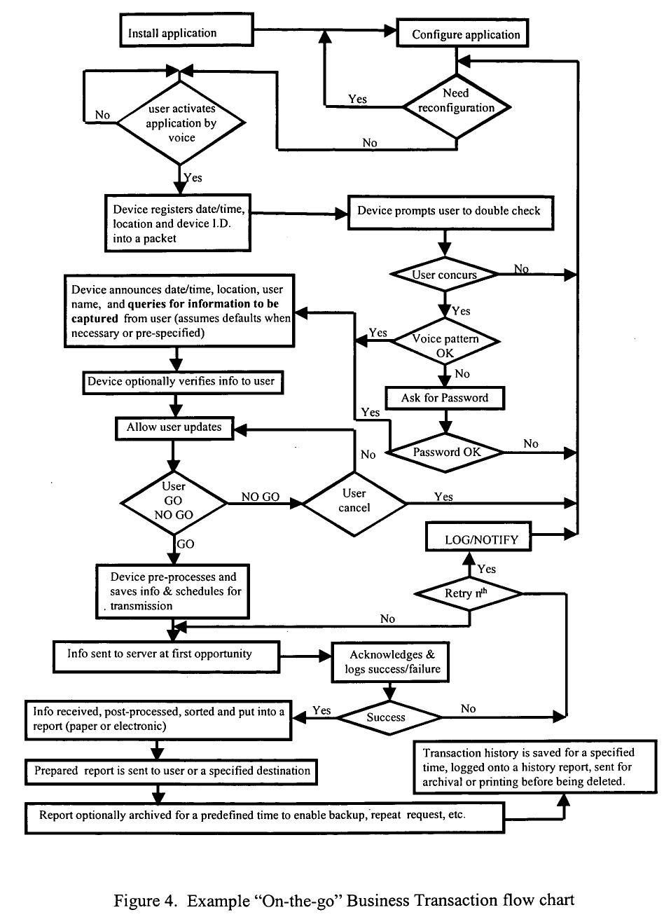

FIG. 4 describes a particular embodiment of the present invention. This embodiment enables a user to conveniently capture and/or track a personal or business transaction. The transaction can then be retrieved either individually or as part of a report combining a number of transactions. This embodiment is comprised of the following components:
A CGRD, such as, but not limited to, a mobile telephone, a PSTN device, a Personal Digital Assistant (PDA), a Smart Phone, an Electronic Tablet, any kind of pocket or hand held device, and a laptop or personal computer.
A MNDS, which is located either locally or remotely.
A wired or wireless communication network infrastructure (TN) which allows for communication between the CGRD and the MNDS.
A Client agent (a program or service) which is resident on the CGRD.
A Server agent which is resident on the MNDS.
A data output interface on the MNDS for transmitting Transaction Reports (TR) and other pertinent information to a specified location or locations.
   The system of this embodiment utilizes a Client Agent on the CGRD, and this Client Agent may or may not be left running in the background while other functions of the CGRD are used. A pre-programmed user command, either by keyboard or by voice (with or without a microphone) initiates a function within the Client Agent. The user then inputs data into the CGRD using either voice or keyboard. The latter is particularly useful for noisy environments. Using either voice or screen display, the CGRD then prompts the user for the next input command. The remote device screen shows the keyboard options available for selection, and the input is then acknowledged by the CGRD, again using voice or screen display. The data received is processed into space efficient compressed or converted information at each step. If the interaction with the Client Agent is suspended, it can resume where the user had left off at the last completed entry. Throughout this input/output interface process the CGRD enables the user to modify any information previously entered, or to delete the transaction and quit the Client Agent. The CGRD responds to each user input by an intended action in the transaction sequence, followed by a prompt for the next input, or for cancellation or other command from the user. This data/command entry sequence continues until the logical conclusion of the transaction, at which time the device, if so configured, offers the user the option of reviewing the transaction.

Upon completion of the entry of the transaction data, the user then indicates that the transaction is complete using either voice or by keyboard command. The CGRD then prepares to transmit the transaction data to the MNDS in the form of a transaction data packet (TD). In addition to the user created content, the client agent can create additional information such as, but not limited to, the user name, type of transaction, location, date, and time, for insertion in the TD. When this step is complete, the Client Agent is enabled to accept the next transaction, subject to memory space available on the device, thereby able to queue multiple transactions. The CGRD then transmits the TD packet or packets as soon as the CGRD detects that the communication network infrastructure is ready to do so. Successful transmittal of the TD packet(s) is then communicated to the CGRD.

In the case of a mobile telephone device for example, the MNDS will be accessed via the wireless data network of the phone service provider. Once the TD packet is received by the MNDS, the MNDS proceeds to process the data depending upon the nature of the transaction identified by the header and other identification parameters. The MNDS also makes use of user-selected or default configuration pre-specified into the MNDS and/or the Client Agent.

Processing of the transaction data packet by the MNDS can be enabled to yield a report, which describes one or more of a sequence of related transactions. This report is then transmitted to a destination device, at a logical or a physical address, based on either user-specified default or built in system settings. The data received into the MNDS and any reports produced by it can be retained by the MNDS for a specified time period in order to enable replication, in case of a future request for backup or archived information. Once the MNDS data is considered to be obsolete, it can be erased, printed or archived as historical data, as appropriate or as pre-configured.

On-the-go Transaction Capture, Tracking, Transmittal and Reporting System

One embodiment of an application in accordance with the present invention is a transaction capture system that supports portable, networked, voice-capable input/output devices. This embodiment will enable a user to conveniently capture and/or track a personal or business transaction as and when it occurs, validate it, transmit it to a remote system immediately (or at the earliest opportunity) thereafter, and provide an easy archival and subsequent retrieval of the transaction, individually or as part of a combined report. The system will be accessible from a wide variety of networked or networkable devices.

System Components and their Interaction:

a. A remote transaction data entry device (TE), which is a portable, networked, voice input/output supporting device, with or without keyboard entry. Examples of representative TE include: a cellphone, PDA, smart-phone, electronic tablet, any form of pocket device including a computer platform, or a laptop.
b. A Transaction Processing Server (TPS), located locally or remotely.
c. A wired or wireless communication network infrastructure (TN), connecting the TE with the TPS.
d. A client application (CA) resident on the TE.
e. A server application (SA) resident on the TPS.
f. A data output interface on the TPS for transmitting transaction reports and other pertinent information (TR) to a specified destination.
g. Interaction of system components:
   i. TE initiates its function by a user command, and accepts further commands and data via its input ports (such as a microphone or a keypad).
   ii. If necessary, TE prompts the user for the next input via voice or screen display, and acknowledges this input in the appropriate manner.
   iii. TE enables the user to fix any errors occurring during this phase, or delete the entire transaction at any point, using the above input/output interfaces.
   iv. Once a transaction is complete, as indicated by a satisfactory termination command by the user, TE prepares to transmit this transaction to TPS, optionally along with additional pertinent header data in the form of a transaction data (TD) packet, and transmits once it detects that TN is prepared to accept transmission.
   v. Once the TD packet is received by TPS, the TPS proceeds to process the data as appropriate, depending on the nature of the transaction identified by its header and other identification parameters. The TPS also employs user-selected or default configuration information pre-specified into the TPS.
   vi. Once the TPS process is applied to a transaction, a report describing one or more of a sequence of related transactions can be enabled.
   vii. This report can then be transmitted to a destination device, logical or physical address, based on user-specified, default or built-in system settings.

The data received into the TPS and any reports produced by it are retained by the TPS for a specified time period, in order to enable replication in case of a future request for backup or archived information.

This embodiment can be implemented with a variety of remote devices, including, but not limited to:
A smart-phone (cell-phone with PDA functionality) instead of the regular cell-phone.
A PDA, with or without wireless connectivity, in which case it would be hooked into a local wired network to access the Transaction Server TPS.
A PC tablet, with pen, keyboard and voice input/output, and network connectivity.
A specialty, vertical niche handheld device with appropriate input/output and connectivity.
A laptop (or even a desktop) computer.
   The present invention is intended to work optimally with a very compact, wireless-networked voice input/output device as the TE, desirably one that can be carried on the person by its user: such as a cellphone.
The client application (CA) is downloaded by service provider, installed on the TE and is preferably left running in the background.
CA is enabled only when TE is not in use for its primary function, such as a phone call being active.
The user activates the CA by speaking a pre-programmed keyword into the device.
The device acknowledges with a voice response, and prompts for user's first input, as it internally prepares a transaction data packet TD to store the transaction.
At any point from now till the end of transaction, the user has the option to cancel the last input or delete the entire transaction if he so chooses.
TE responds to each user input by an intended action in the transaction sequence, followed by prompt for the next input, or for cancel or other commands from the user.
The user can optionally enter a command or parts or all of the data from the keyboard if he so chooses. This can enable the user to enter or edit crucial parts of data or commands more accurately on the first attempt, especially in a noisy environment.
The device screen shows the user the keyboard options he can select from at each step.
The data received is processed into space efficient compressed or converted information at each step.
If CA is suspended due to an intervening phone call, it resumes where the user had left off at his last completed entry.
This data/command entry sequence continues till the logical conclusion of the transaction, at which time the device, if so configured, offers user the option of reviewing the transaction.
Upon a final OK from user, TE completes TD with date/time/location/user kind of “stamp”, and readies it for transfer to the Transaction Server TPS via the TN network. In case of a cell-phone for example, TPS will be accessed via the wireless data network of the phone service provider.
When this step is complete, the CA becomes ready for accepting the next transaction, subject to device space available, thereby able to queue multiple transactions.
Each TD queued in the device is transmitted to TPS at the first opportunity when TN become available for the purpose, with usual transfer verifications.
While they have convenient default selections built-in, TPS and CA are both configurable by the user according to his needs and preferences. For example, TPS would typically be configured for processing a set of connected transactions of each given user into a summary report.
This report is then transmitted to appropriate destination electronically according the pre-configured selections made by the user.
   TPS and CA both maintain a copy of data prepared by them for a length of time, to enable recovery and request for re-transmittal. Once the TPS data is deemed as no longer needed, it is discarded, printed or archived as historical data, as appropriate or as pre-configured.
   GoExpense Application Embodiment

A further embodiment of an application in accordance with the present invention is a cellular phone centric instant expense management system, which can identify the users, and detect where and when an expense was entered/incurred.

Such an application will have the following features:
Application (“App”) activated by spoken command ‘Expense’ into the cellphone.
(App when opened attempts to verify the user by voice pattern, failing which it prompts to enter a password to provide security.)
App prompts the user by “What expense?”
User responds by saying, e.g., “Lunch with client X . . .”, or “Taxi Cab”
App prompts “Amount?”
User speaks the amount, or punches in digits (in whatever format has been pre-determined, e.g. rounded currency)
If CA is suspended due to an intervening phone call, it resumes where the user had left off at his last completed entry.
This data/command entry sequence continues till the logical conclusion of the transaction, at which time the device, if so configured, offers user the option of reviewing the transaction.
Upon a final OK from user, TE completes TD with date/time/location/user kind of “stamp”, and readies it for transfer to the Transaction Server TPS via the TN network. In case of a cell-phone for example, TPS will be accessed via the wireless data network of the phone service provider.
When this step is complete, the CA becomes ready for accepting the next transaction, subject to device space available, thereby able to queue multiple transactions.
Each TD queued in the device is transmitted to TPS at the first opportunity when TN become available for the purpose, with usual transfer verifications.
While they have convenient default selections built-in, TPS and CA are both configurable by the user according to his needs and preferences. For example, TPS would typically be configured for processing a set of connected transactions of each given user into a summary report.
This report is then transmitted to appropriate destination electronically according the pre-configured selections made by the user.
   TPS and CA both maintain a copy of data prepared by them for a length of time, to enable recovery and request for re-transmittal. Once the TPS data is deemed as no longer needed, it is discarded, printed or archived as historical data, as appropriate or as pre-configured.
   GoExpense Application Embodiment

A further embodiment of an application in accordance with the present invention is a cellular phone centric instant expense management system, which can identify the users, and detect where and when an expense was entered/incurred.

Such an application will have the following features:
application (“app”) activated by spoken command ‘expense’ into the cellphone.
(app when opened attempts to verify the user by voice pattern, failing which it prompts to enter a password to provide security.)
app prompts the user by “what expense?”
user responds by saying, e.g., “lunch with client x . . .”, or “taxi cab”
app prompts “amount?”
user speaks the amount, or punches in digits (in whatever format has been pre-determined, e.g. rounded currency)

1. A system for exchanging and processing information between a remote device communicating with a network server, the system comprising:
at least one user-interactive remote device including a computer platform having a client agent resident therein, said device in selective communication with a network;
at least one network server having a server agent resident therein, said network server in selective communication with the network and the remote device, and said network server having a data output interface for providing access to data; wherein, said client agent selectively communicates data provided in at least one predefined format by the user of the remote device to the server agent for processing by the server agent and the generation of data accessible through said data output interface; and wherein said server agent selectively communicates data in at least one predefined format to the client agent for processing by the client agent, to other destination client agents and/or processes data received and makes that accessible to the user of the remote device.

2. A system as recited in claim 1 wherein at least one of said remote device is selected from the group consisting of cell/mobile phones, smart phones, wireless telephones, PDAs, custom mobile data devices, messaging devices, electronic tablets, touch input screens, electronic chalkboards and whiteboards, PSTN or other network connected devices, and computers.

3. A system as recited in claim 1 wherein the data provided by the remote device automatically includes at least one of identity of the user, location of the user, date and time.

4. A system as recited in claim 1 wherein the data provided to the remote device by the user to client agent is provided by voice input, keypad or other mechanical entry.

5. A system as recited in claim 1 wherein the data provided by the remote device is validated, filtered or preprocessed by the client agent.

6. A system as recited in claim 1 wherein the data input to the remote device remains resident in the client agent until communication established with the network server.

7. A system as recited in claim 1 wherein data received by the server agent is processed as intended by the application in question.

8. A system as recited in claim 1 wherein data received by the server agent is processed as pre-specified by the user.

9. A system as recited in claim 1 wherein data received by the server agent is processed by a built-in default set of rules.

10. A system as recited in claim 1 wherein inputted data remains resident in the server agent until communication established with at least one of: (1) the originating remote device, (2) other destination remote devices, (3) user specified, pre-selected, pre-configured device/computer/networked-server, or (4) a default receiving device/computer/networked-server.

11. A system as recited in claim 1 comprising a plurality of remote devices and/or network servers interactively communicating.

12. A system as recited in claim 1 wherein said server includes at least one database for storage of data.

13. A system as recited in claim 1 wherein data is archived for future access by the server agent.

14. A system as recited in claim 1 wherein the server agent combines data from separate transactions and remote device sources for either user-specific or enterprise-specific data access.
